(19) United States
(12) Patent Application Publication
(10) Pub. No.: US 2004/0035468 A1
(43) Pub. Date: Feb. 26, 2004

(54) Discharge valve and compressor using the same

(76) Inventor: Jae-Sul Shim, Busan (KR)

Correspondence Address: Fleshner & Kim, P O Box 221200, Chantilly, VA, 20153-1200, US

(21) Appl. No.: 10/381,003

(22) PCT Filed: Nov. 4, 2002
(86) PCT No.: PCT/KR02/02048

(30) Foreign Application Priority Data
Nov. 9, 2001 (KR) 2001-69853

(51) Int. Cl. F16K 21/10

(52) U.S. Cl. 137/514

(57) ABSTRACT

Disclosed is a discharge valve for a compressor comprising a cylinder having a discharge hole for discharging a fluid; a valve plate provided at an outer portion of the cylinder for opening and closing the discharge hole; a retainer located behind the valve plate for limiting an opened range of the valve plate; and a plurality of micro dimples formed in at least one contacted portion among a periphery of the discharge hole to which the valve plate is contacted, the retainer, and the valve plate.

### TECHNICAL FIELD

The present invention relates to a discharge valve used at a fluid machine and a compressor using the same, and more particularly, to a discharge valve and a compressor using the same, in which noise is reduced at the time of operating the valve.

### BACKGROUND ART

In general, a compressor corresponding to a kind of a fluid machine is a device for sucking a fluid in a cylinder, compressing, and discharging the fluid by using a rotary movement of a piston engaged to a driving motor and a linear reciprocal movement. The cylinder of the compressor is provided with a discharge valve for limiting a discharge fluid.

FIG. 1 is a sectional view showing a reed valve the most widely used as a discharge valve for a compressor, and FIG. 2 is a plane view of a discharge valve seen at the II-II direction of FIG. 1.

Referring to FIGS. 1 and 2, the conventional discharge valve for a compressor will be explained.

The conventional discharge valve comprises a valve body having a discharge hole 1a or a cylinder (hereinafter, will be called as a cylinder 1), a valve plate 2 for opening and closing the discharge hole 1a of the cylinder 1, and a retainer 3 located behind the valve plate 2 for limiting an opened range of the valve plate 2.

A valve seat 1b to which the valve plate 2 is contacted is formed at a peripheral portion of the discharge hole 1a of the cylinder 1. The valve seat 1b is protruded as a ring shape so as to prevent noise from occurring when the valve plate 2 is closed and a fluid in the cylinder 1 from being leaked.

The valve plate 2 formed as a long plate shape for opening and closing the discharge hole 1a includes one end portion fixed to the cylinder 1 by a bolt 4 and the other end portion contacted to the valve seat 1b.

The retainer 3 includes one end portion fixed to the cylinder 2 with the valve plate 2 by the bolt 4 and the other end portion rounded towards a direction the valve plate 2 is opened.

In the conventional discharge valve for a compressor, the valve plate 2 is adhered to the valve seat 1b by its elastic force and opened towards the retainer 2 with a bending when a pressure in the cylinder 1 is above a predetermined value. At this time, the fluid compressed in the cylinder 1 is discharged at an outer side of the cylinder 1 through the discharge hole 1a.

However, in the conventional discharge valve for a compressor, much noise occurs as a frontal side of the valve plate 2 corresponding to a pressure side and a back side corresponding to a pressure rear side respectively collide to the valve seat 1b and the retainer 3 when the valve plate 2 is opened and closed.

The noise can be reduced by installing buffering members such as a rubber member at a contacted or collided side with the valve plate 2. However, in case of using the additional buffering members, a construction becomes complicated, so that a productivity is lowered. Also, if the buffering members are used for a long time, they are worn out and damaged, thereby requiring a frequent alternation.

### DISCLOSURE OF THE INVENTION

Therefore, it is an object of the present invention to provide a discharge valve for a compressor, in which a shock generated when a valve plate is contacted to is attenuated and noise occurrence is minimized by forming micro dimples for containing oil at a contacted portion with the valve plate.

Also, it is another object of the present invention to provide a compressor which can reduce noise generated at the time of operating the compressor by providing a discharge valve having micro dimples at a contacted portion with a valve plate.

To achieve these objects, there is provided a discharge valve for a compressor comprising a cylinder having a discharge hole for discharging a fluid, a valve plate provided at an outer side of the cylinder for opening and closing the discharge valve, and a plurality of micro dimples formed at least one contacted portion between a peripheral portion of the discharge hole to which the valve plate is contacted and the valve plate.

The micro dimples can be formed only at a peripheral portion of the discharge hole or only at the valve plate. Also, the micro dimples can be formed at both the discharge hole and the valve plate.

In the meantime, a valve seat is protruded outwardly at a peripheral portion of the discharge hole to which the valve plate is contacted, and the micro dimples can be formed at the valve seat.

The discharge valve is located behind the valve plate and provided with a retainer for limiting an opened range of the valve plate. The retainer can be provided with micro dimples at a contacted side with the valve plate.

Also, to achieve these objects, there is provided a discharge valve for a compressor comprising a cylinder having a discharge hole for discharging a fluid, a valve plate provided at an outer portion of the cylinder for opening and closing the discharge hole, a retainer located behind the valve plate for limiting an opened range of the valve plate, and a plurality of micro dimples formed in at least one contacted portion among a pheripheral portion of the discharge hole to which the valve plate is contacted, the retainer, and the valve plate.

The micro dimples can be formed at a peripheral portion of the discharge hole, at the retainer, or at both sides of the valve plate.

Also, to achieve these objects, there is provided a compressor comprising a cylinder assembly having a suction hole and a discharge hole; a Z-plate for dividing an inner space of the cylinder assembly into a plurality of compression chambers and for sucking, compressing, and discharging a fluid by being rotated by a motor unit; vanes contacted to both sides of the Z-plate for dividing the respective compression chambers into a suction region and a compression region with a reciprocal movement; and a valve plate provided at an outer side of the cylinder assembly for opening and closing the discharge hole according to a pressure change in the compression chamber, wherein a plurality of micro dimples are formed in at least one contacted portion between the valve plate and a peripheral portion of the discharge hole to which the valve plate is contacted.

The compressor is located behind the valve plate and further includes a retainer for limiting an opened range of the valve plate.

The retainer is provided with micro dimples at a contacted side with the valve plate or the valve plate is provided with micro dimples at a contacted side with the retainer.

### BRIEF DESCRIPTION OF THE DRAWINGS

FIG. 1 is a longitudinal sectional view showing a discharge valve for a compressor in accordance with the conventional art;

FIG. 2 is a plane view seen at the II-II line direction of FIG. 1;

FIG. 3 is a longitudinal sectional view showing one embodiment of a discharge valve for a compressor according to the present invention;

FIG. 4 is a plane view seen at the IV-IV line direction of FIG. 3;

FIG. 5 is a detail view for main parts showing another embodiment of a discharge valve for a compressor according to the present invention;

FIG. 6 a detail view for main parts showing another embodiment of a discharge valve for a compressor according to the present invention;

FIG. 7 is a longitudinal sectional view showing a rotary compressor to which a discharge valve, according to the present invention is applied;

FIG. 8 is a longitudinal sectional view showing a reciprocating compressor to which a discharge valve according to the present invention is applied;

FIG. 9 is a longitudinal sectional view showing a scroll compressor to which a discharge valve according to the present invention is applied; and

FIG. 10 is a longitudinal sectional view showing a Z-compressor to which a discharge valve according to the present invention is applied.

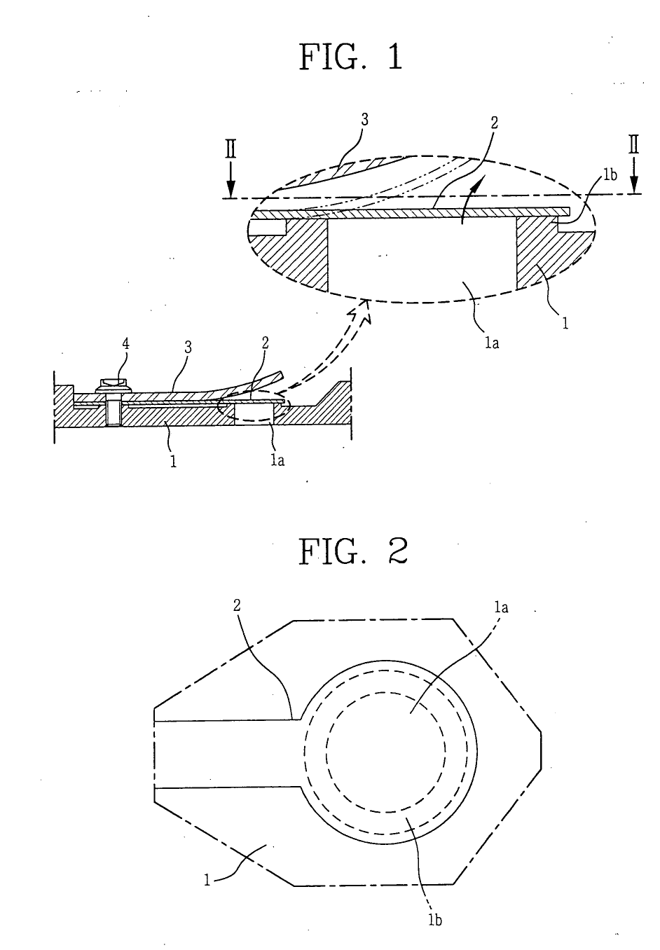

### MODES FOR CARRYING OUT THE PREFERRED EMBODIMENTS

Hereinafter, the discharge valve for a compressor according to the present invention will be explained with reference to the attached drawings.

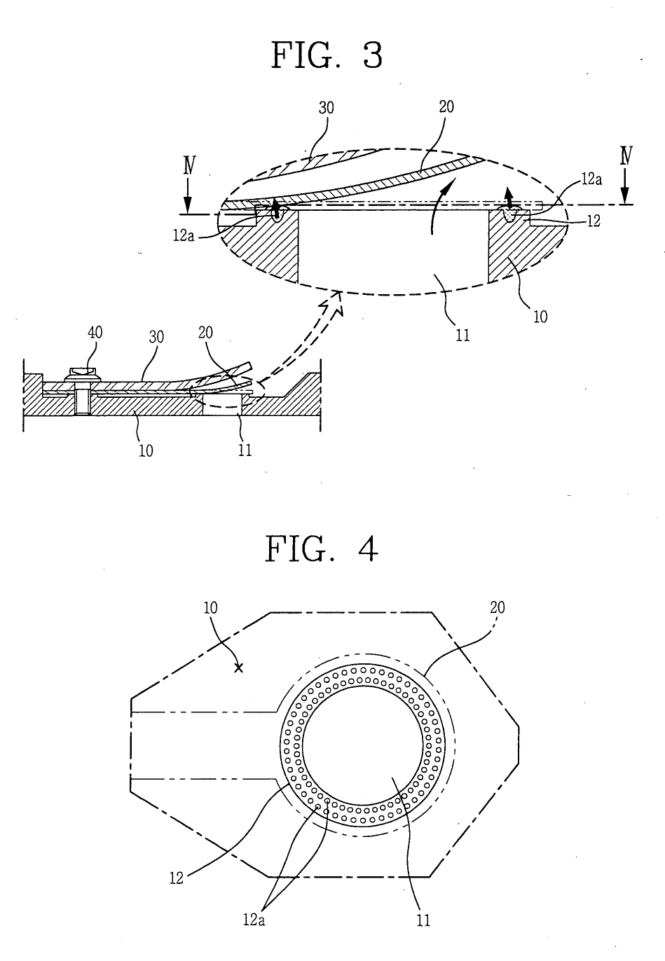

FIG. 3 is a longitudinal sectional view showing one embodiment of the discharge valve for a compressor according to the present invention, and FIG. 4 is a plane view seen at the IV-IV line direction of FIG. 3, in which a reference numeral 10 denotes a valve body portion generally corresponding to a cylinder in a compressor. The cylinder 10 is provided with a compression chamber therein, and a discharge hole 11 for discharging a fluid compressed in the compression chamber at an outer side of the cylinder.

A valve plate 20 for opening and closing the discharge hole 11 is fixed to an outer portion of the cylinder 10 by a bolt 40.

Also, a retainer 30 for limiting an opened range of the valve plate 20 is fixed to an outer portion of the cylinder 10 by the bolt 40 with the valve plate 20.

A valve seat 12 for preventing noise and a fluid leakage when the valve plate 20 is opened or closed is protruded as a ring shape at a peripheral portion of the discharge hole 11 to which the valve plate 20 is contacted.

Especially, the valve seat 12 is provided with a plurality of micro dimples 12a at a contacted side with the valve plate 20.

When a compression fluid is discharged at an outer side of the cylinder 10, the micro dimples 12a make a part of oil mixed with the discharge fluid remain.

That is, in the compressor; oil is mixed with refrigerant gas and flows with the refrigerant gas. When the oil mixed with the refrigerant gas is discharged outwardly through the discharge hole 11, the oil remains at the micro dimples 12a of the valve seat 12. According to this, a shock or noise generated when the valve plate 20 is adhered to or apart from the valve seat 12 is reduced.

Operations of the discharge valve according to the present invention will be explained.

If the compression unit starts a compression process, a pressure of the compression chamber in the cylinder 10 exceeds a predetermined value and the valve plate 20 closing the discharge hole 11 of the cylinder 10 is opened by compression gas of high pressure. Then, if the compression unit starts a suction process, a pressure of the compression chamber falls below a predetermined value and the valve plate 20 returns by its elastic force, thereby closing the discharge hole 11.

At this time, the valve plate 20 can cause noise by being collided with the valve seat 12 by its restoration force at a peripheral portion of the discharge hole 11. However, in the present invention, since the valve seat 12 is provided with the plurality of micro dimples 12a and a part of oil mixed with the discharge gas remains at the micro dimples 12a and 31a, the noise generated when the valve plate 20 collides with the valve seat 12 is buffered by the oil playing a role of damping.

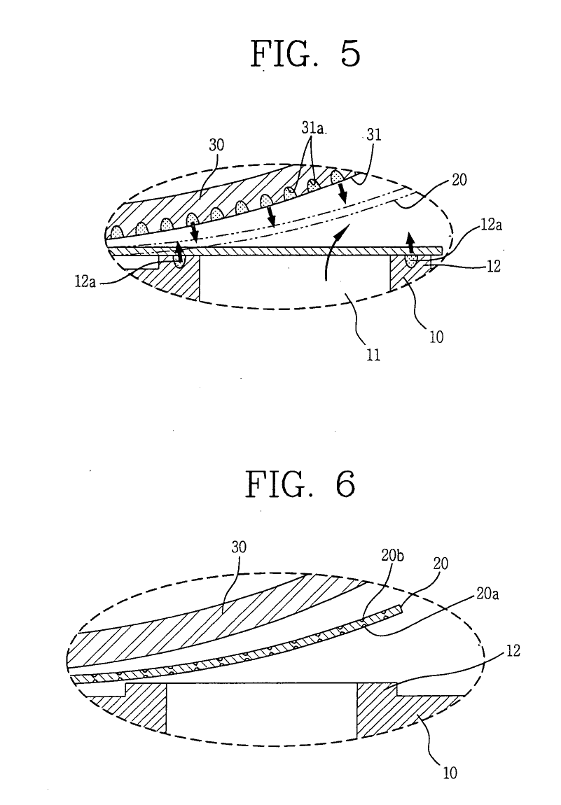

FIG. 5 is a detail view showing that the micro dimples are formed at the retainer as another embodiment of the discharge valve for a compressor according to the present invention, and FIG. 6 is a detail view showing that the micro dimples are formed at the valve plate as another embodiment of the discharge valve for a compressor according to the present invention.

As shown in FIG. 5, a plurality of micro dimples 31a for buffering a shock or noise by receiving a part of the discharge gas or oil are formed at a stopper surface 31 of the retainer 30 to which a rear surface of the valve plate 20 is contacted

It is also possible to form the micro dimples 12a and 31a at both the valve seat 12 of the cylinder 10 and the retainer 30 like the aforementioned one embodiment.

Accordingly, when the valve plate 20 collides with the valve seat 12 of the cylinder 10 or the stopper surface 31 of the retainer 30 by a strong discharge pressure or a restoration force, the oil which remains at the micro dimples 12a or 31a attenuates the generated noise.

Referring to another embodiment shown in FIG. 6, micro dimples 20a or 20b can be formed at the valve plate 20 differently from the aforementioned one embodiment of the present invention.

The micro dimples 20a or 20b can be formed either at a frontal side of the valve plate 20 or at a rear side, or can be formed at both sides.

Oil contained in the micro dimples 20a or 20b reduces noise generated when the valve plate 20 provided with the micro dimples 20a or 20b collides with the valve seat 12 and the retainer 30.

Generally, a compressor applied to a refrigerating cycle system such as an air conditioner and a refrigerator is largely divided into a rotary compressor, a reciprocating compressor, and a scroll compressor by compression methods.

Principles to apply the discharge valve according to the present invention to the rotary compressor, the reciprocating compressor, and the scroll compressor will be explained.

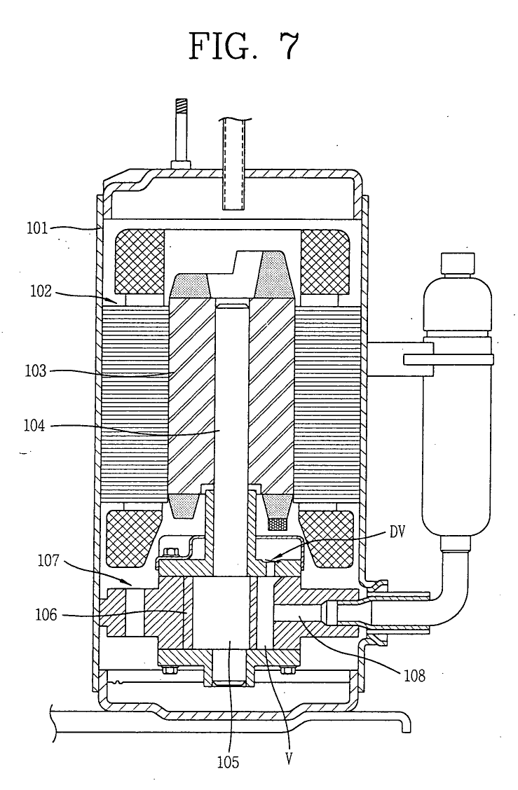

First, as shown in FIG. 7, in the rotary compressor provided with a discharge valve of the present invention, as a motor unit 102 mounted in a casing 101 is operated, a rotator 103 and a rotary axis 104 are rotated. At this time, a rolling piston 106 mounted to an eccentric portion 105 of the rotary axis 104 rotates along an inner circumference surface of a cylinder 107, compresses a fluid sucked in the compression chamber V through a suction hole 108, and discharges the fluid at an outer side of the cylinder 107 through the discharge valve DV according to the present invention, which is repeated.

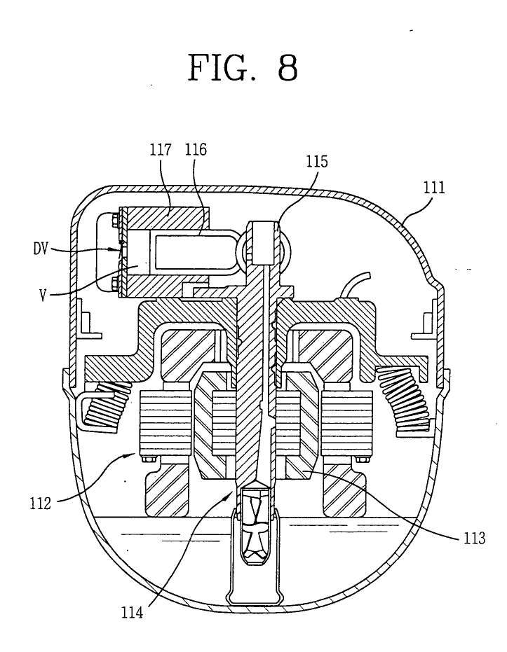

Next, as shown in FIG. 8, in the reciprocating compressor provided with the discharge valve of the present invention, as a motor unit 112 mounted in a casing 111 is operated, a rotator 113 and a crank axis 114 are rotated. At this time, a piston 116 mounted to an eccentric portion 115 of the crank axis 114 reciprocates linearly in the compression chamber V of the cylinder 117, compresses a sucked fluid, and discharges the fluid at an outer side of the cylinder 117 through the discharge valve DV according to the present invention, which is repeated.

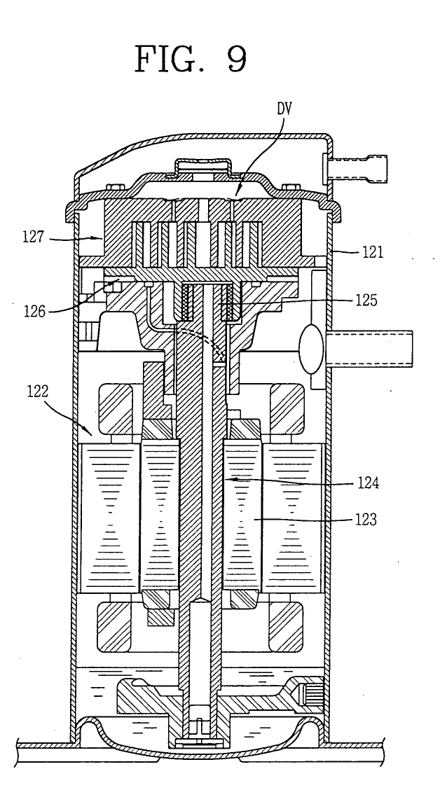

Next, as shown in FIG. 9, in the scroll compressor provided with the discharge valve of the present invention, as a motor unit 122 mounted in a casing 121 is operated, a rotator 123 and a rotary axis 124 are rotated. At this time, an orbit scroll 126 connected to an eccentric portion 125 of the rotary axis 124 makes a turning movement engagingly with a fixed scroll 127, compresses a fluid, and discharges the fluid at an outer side of the cylinder 117 through the discharge valve DV according to the present invention, which is repeated.

The discharge valve DV of the present invention applied to the rotary compressor, the reciprocating compressor, and the scroll compressor is provided with the micro dimples at a contacted side with the valve plate, thereby reducing noise generated by the discharge valve at the time of operating the compressor.

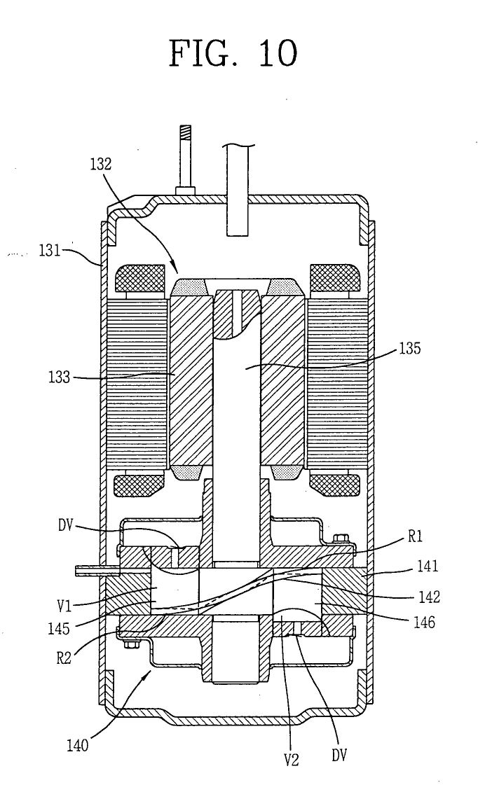

In the meantime, FIG. 10 illustrate a compressor of a novel concept (hereinafter Z-compressor) disclosed to the patent laid-open publication of Korean Industrial Patent Office in May 7, 2001 with the publication number 2001-35687.

The Z-compressor having the discharge valve of the present invention includes a motor unit 132 provided at an inner portion of a hermetic casing 131 for generating a rotary force, and a compression unit 140 for sucking, compressing, and discharging a fluid by the rotary force generated at the motor unit 132.

The compression unit 140 includes a cylinder assembly 141 fixed at a lower side of the casing 131 for forming a compression chamber where a fluid sucked from an outer side is compressed; a rotary axis 135 for transmitting a rotary force generated at a rotor 133 of the motor unit 132; a Z-plate 142 engaged to the rotary axis 135 and rotated for dividing the compression chamber of the cylinder assembly 141 into a first space V1 and a second space V2; and first and second vanes 145 and 146 provided with elastic force by a spring (not shown) and contacted to upper and lower surfaces of the Z-plate 142 for dividing the respective spaces V1 and V2 into a suction region and a compression region when the Z-plate 142 is rotated.

Especially, the Z-plate 142 is formed as a circular shape at the time of a plane projection so that an outer circumference surface of the Z-plate may be slidably contacted to an inner surface of the cylinder assembly 141. Also, a lateral side of the Z-plate is formed as a cam surface of a sine wave curved line having a same thickness from the inner circumference surface of the cylinder assembly to the outer circumference surface of the rotary axis when unfolded, so that a surface constituting an upper dead point R1 is contacted to an upper surface of the compression space V1 to rotate, and a surface constituting a lower dead point R2 is adhered to a lower surface of the compression space V2 to rotate.

In the Z-compressor, if the rotary axis 135 is rotated by a driving force of the motor unit 132, the Z-plate 142 engaged to the rotary axis 135 in the cylinder assembly 141 simultaneously rotates to suck a fluid, compress, and discharge the fluid at an outer side of the cylinder assembly 141 through the discharge valve DV of the present invention.

In the Z-compressor, a pressure pulsatory noise at the time of discharging the fluid and a contact noise among components including the discharge valve are generated and the noise is emitted to an outer side of the casing 131. However, the discharge valve according to the present invention can reduce the noise emitted to the outer side of the compressor by reducing the valve noise by the residual oil at the micro dimples.

1. A discharge valve for a compressor comprising:
a cylinder having a discharge hole for discharging a fluid;
a valve plate provided at an outer side of the cylinder for opening and closing the discharge valve; and
a plurality of micro dimples formed at least one contacted portion between a peripheral portion of the discharge hole to which the valve plate is contacted and the valve plate.

2. The discharge valve of claim 1, wherein the micro dimples are formed at a peripheral portion of the discharge hole.

3. The discharge valve of claim 1, wherein the micro dimples are formed at the valve plate.

4. The discharge valve of claim 1, wherein the micro dimples are formed at both the discharge hole and the valve plate.

5. The discharge valve of claim 1, wherein a valve seat to which the valve plate is contacted is protruded outwardly at a peripheral portion of the discharge hole, and the micro dimples are formed at the valve seat.

6. The discharge valve of claim 1, wherein the discharge valve is located behind the valve plate and provided with a retainer for limiting an opened range of the valve plate.

7. The discharge valve of claim 6, wherein the retainer is provided with micro dimples at a contacted side with the valve plate.

8. A discharge valve for a compressor comprising:
a cylinder having a discharge hole for discharging a fluid;
a valve plate provided at an outer portion of the cylinder for opening and closing the discharge hole;
a retainer located behind the valve plate for limiting an opened range of the valve plate; and
a plurality of micro dimples formed in at least one contacted portion among a peripheral portion of the discharge hole to which the valve plate is contacted, the retainer, and the valve plate.

9. The discharge valve of claim 8, wherein the micro dimples are formed at a peripheral portion of the discharge hole and at the retainer.

10. The discharge valve of claim 8, wherein the micro dimples are formed at both sides of the valve plate.

11. A compressor comprising:
a cylinder assembly having a suction hole and a discharge hole;
a Z-plate for dividing an inner space of the cylinder assembly into a plurality of compression chambers and for sucking, compressing, and discharging a fluid by being rotated by a motor unit;
vanes contacted to both sides of the Z-plate for dividing the respective compression chambers into a suction region and a compression region with a reciprocal movement; and
a valve plate provided at an outer side of the cylinder assembly for opening and closing the discharge hole according to a pressure change in the compression chamber,
wherein a plurality of micro dimples are formed in at least one contacted portion between the valve plate and a periphery of the discharge hole to which the valve plate is contacted.

12. The compressor of claim 11, wherein the compressor is located behind the valve plate and further includes a retainer for limiting an opened range of the valve plate.

13. The compressor of claim 12, wherein the retainer is provided with micro dimples at a contacted side with the valve plate.

14. The compressor of claim 12, wherein the valve plate is provided with micro dimples at a contacted side with the retainer.
